(19) United States
(12) Patent Application Publication
(10) Pub. No.: US 2016/0071709 A1
(43) Pub. Date: Mar. 10, 2016

(54) Apparatus and Methods for Controlling Miniaturized Arrays of Ion Traps

(71) Applicant: Paul I. Hendricks, Los Gatos, CA (US)

(72) Inventor: Paul I. Hendricks, Los Gatos, CA (US)

(73) Assignee: BAYSPEC, INC., San Jose, CA (US)

(21) Appl. No.: 14/483,098

(22) Filed: Sep. 10, 2014

(51) Int. Cl. H01J 49/00; H01J 49/06

(52) U.S. Cl. CPC H01J 49/0013; H01J 49/06

(57) ABSTRACT

Apparatus and methods for controlling miniaturized arrays of ion traps, including cylindrical ion traps, rectilinear ion traps, and linear ion traps. Improved methods for applying supplemental AC signals to individual ion traps in an ion trap array. Methods of organizing ion trap arrays and operating the arrays in a manner to improve sensitivity, resolution and mass accuracy. Techniques for performing simultaneous detection of multiple compounds from ion trap arrays. Optimization of ion trap performance by dynamic optimization or adjustment of RF trapping frequency and voltage amplitude.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The invention relates generally to the field of mass spectrometry and specifically to devices and methods for controlling and operating miniaturized arrays of ion trap mass spectrometers.

Over the last several decades, mass spectrometers have progressed steadily in the direction of smaller, lighter, and more portable instrumentation. Initially, mass spectrometers were large instruments built around magnetic and electric sector analyzers which required large vacuum systems that ultimately weighed hundreds of pounds. Currently, powerful mass spectrometers can be built with ion traps, which are fundamentally small devices which have the capability to store and mass analyze ions using RF electric trapping fields.

With the introduction of quadrupole mass filters and ion traps, mass spectrometers have become smaller, lighter, and recently, in the extreme, have become portable. Some mass spectrometers are now handheld, allowing the mass spectrometer to be taken to the field, allowing for on-site sample analysis, as opposed to the sample being collected in the field and then transported to a laboratory where it is analyzed with a conventional mass spectrometer.

A dramatic step forward in the miniaturization of mass spectrometry has been twofold: First, the ability to manufacture quadrupole analyzers with critical dimensions at the mm and sub-mm scales; the second is the ability to physically create arrays of miniaturized mass analyzers.

Ion trap arrays have typically been implemented through fabrication of large numbers of cylindrical ion traps (CITs) onto a physical substrate. Although each individual ion trap in the array has a limited ion storage capacity and analytical performance, the parallel or serial operation of hundreds, thousands, and perhaps even a million individual ion traps has been shown to produce mass spectra comparable with that of conventional mass spectrometers. In addition, the smaller geometry permits the ion trap array to operate at much higher pressures (reducing the vacuum requirements), and at lower RF voltage amplitudes than previous mass spectrometer configurations. These benefits have lead to the ability to create compact ion trap mass analyzers for miniaturized mass spectrometers that are capable of in-field sample analysis.

One of the first constructions of an ion trap array was described by Brewer (U.S. Pat. No. 5,379,000) in which an ion trap array was used to construct an atomic clock. This early design by Brewer comprised sheets of ring-shaped conductive members, in which the conductive rings functioned as the ring electrodes in an array of miniature ion traps. This design was intended to confine a single ion in each individual ion trap. The design was specifically targeted towards construction of an atomic clock, and not for the purpose of mass analysis or for any other component of a miniature mass spectrometer.

The Brewer design was based on an ion trap configuration in which ions are confined by three electrodes. This configuration comprises a central (ring) electrode, with two additional electrodes (endcaps) on either side of the ring electrode. Ideally, the ring electrode and both endcaps will have a hyperbolic shape. However, it is also possible to construct a three-dimensional ion trap with a simplified geometry in which the ring electrode has a cylindrical shape, and the endcaps both have a planar disc shape. The cylindrical ion trap (CIT) configuration has proven to be very popular as an ion storage device and as a mass analyzer in the construction of large scale ion trap arrays due to its simplified geometry, allowing it to be highly miniaturized and controlled via integrated circuit technology.

A subsequent design by Cooks (U.S. Pat. No. 6,762,406) described the construction of a mass spectrometer with a parallel array of cylindrical ion traps. This design made use of a conductive sheet containing a plurality of holes drilled in the material, with each hole functioning as a cylindrical ring electrode. The material was then covered on each side by a separate conductive sheet that functioned as the endcaps for each of the individual ion traps in the array. Ions were trapped with the conventional approach of applying both RF and DC to the ring electrode and endcaps. In addition, individual ion species were isolated by applying SWIFT (Stored Waveform Inverse Fourier Transform) waveforms to the endcaps of the individual ion traps. These isolated ion species were subsequently fragmented, generating MS/MS data from the ion trap array. Data generated by the individual CITs in the Cooks' U.S. Pat. No. 6,762,406 patent were shown for ion traps having both 5 and 6 mm ion trap radii. Drawings were also shown for mechanical construction of an ion trap array holding 25 individual CITs.

A patent by Blain (U.S. Pat. No. 6,870,158) described manufacturing techniques for producing an ion trap array containing large numbers of individual CITs, each having a radius of less than 10 μm. The described design made use of individual ion traps each having the same dimensions. The design was fabricated in a hexagonal configuration, in which each individual ion trap was surrounded by six other identical ion traps.

In a presentation made by Tabert et al. “Miniature Mass Spectrometer Based on the Cylindrical Ion Trap (CIT) and Design and Construction of a Rectilinear Ion Trap (RIT)”, data was presented to demonstrate the application of a miniaturized CIT array. The disclosed device was constructed of four CITs, each having a separate detector and separate ion source. This configuration permitted the sampling of four different compounds simultaneously, and also permitted a single sample to be analyzed simultaneously with both EI (electron impact) and CI (chemical ionization). The presentation also demonstrated the use of miniaturized Rectilinear Ion Traps to perform MS/MS and MS/MS/MS analyses.

Another variation on the idea of the cylindrical ion trap array was developed by Ouyang (PCT/US2012/040519) in which the ring electrodes were replaced by electrodes that were square. The endcaps were also modified from their typical planar geometry. The endcaps in this design were created by conductive strips that crossed at right angles to each other.

Development of large-scale ion trap arrays have involved the implementation of different sizes, shapes, and manufacturing procedures for cylindrical ion traps. Although these approaches have generally been successful, they have all been built upon an ion trap design (the cylindrical ion trap) that has known limitations. Both the three-dimensional hyperbolic, and three-dimensional cylindrical, ion trap have limited ion storage capacity. When the ion storage capacity of an ion trap is reached, a space charge condition is developed that results in loss of mass resolution, mass accuracy, and ultimately the loss of sensitivity.

A major improvement in the performance of the ion trap mass spectrometer was achieved with the development of the linear ion trap, described by Bier (U.S. Pat. No. 5,420,425). The linear ion trap is capable of storing roughly an order of magnitude more ions than a three-dimensional ion trap with similar r₀ dimension. In addition, the linear ion trap has been shown to have an improved ion trapping efficiency, and is capable of increased mass scanning rates.

Work has already been done to develop arrays of linear ion traps. In several presentations by Hendricks et al. (“Development of a Miniature Rectilinear Ion Trap Array with Independently Controlled Channels”, “Reduced Scale Rectilinear Ion Trap Arrays”, and “Evaluation of Rectilinear Ion Traps and Ion Trap Arrays”) an array of eight rectilinear ion traps is described. The RITs were fabricated on a printed circuit board with a stereolithography (SLA) process. The RITs had dimensions of 1.67×1.33×16.66 mm, which was one-third the dimension of other RITs that have been well characterized and implemented in portable mass spectrometers. The Hendricks' papers all displayed data showing that the RIT array could generate data comparable with other mass spectrometers, and could also generate MS/MS (Mass Spectrometry/Mass Spectrometry) data through use of SWIFT (Stored Waveform Inverse Fourier Transform) isolation, and subsequent collisionally induced dissociation.

The current status of mass spectrometry miniaturization has shown that arrays of cylindrical ion traps can be constructed from simple machined layers of conductive and non-conductive materials that produce a miniaturized mass spectrometer analyzer containing hundreds, or even thousands, of individual CITs. However, due to the different geometry of the linear ion trap, the development of arrays of linear ion traps has been limited to showing only small numbers of RITs, with each RIT having dimensions in the millimeter region. Additionally, since there was only a small number of RITs, a poorly performing RIT would have a dramatic effect on the overall performance of the mass analyzer resulting in compromised spectral quality. One approach to correcting the behavior of errant, individual ion traps in the ion trap array is to implement individual control for each channel to improve the overall performance of the entire mass analyzer array.

### BRIEF SUMMARY OF THE INVENTION

This invention relates to the construction of arrays of ion traps, and describes geometries and control circuits that allow for improved performance and a level of analytical capability that is not available with mass spectrometers having individual analyzers or mass analyzer arrays with common drive voltages.

The motivation for construction of a miniaturized ion trap array has its origins in basic physics. As the physical size of an ion trap is reduced, the ion trap may be operated at a reduced RF voltage. This reduces the potential for unwanted electrical discharge, which in turn permits operation of the ion trap at a higher pressure. In addition, the shorter distances traveled by the ions in the miniaturized analyzer will result in fewer collisions with neutral molecules, permitting a further increase in operating pressure.

The construction of large numbers of individual ion traps in an ion trap array have typically been achieved through the use of CITs. The use of RITs to construct an ion trap array has been limited to small numbers of RITs. While a CIT can be implemented with just three electrodes (a ring electrode and two endcaps), an LIT will typically require six electrodes (four parallel rods or rectangular plates, and two endcaps).

The implementation of a CIT array has primarily been limited to an array of a large number of cylindrical ion traps having a single common electrical connection to all entrance endcaps, a single common connection to all exit endcaps, and a single common connection to all ring electrodes. Work was also described by Cooks (U.S. Pat. No. 6,672,406) with a small number of cylindrical ion traps, in which each individual CIT had its own detector and its own ion source.

Previously, ion trap arrays comprised large numbers of ion traps in which the entire array was connected in parallel and controlled as if it were a single mass spectrometer. Another technique, described by Hendricks et al. (“Evaluation of Rectilinear Ion Traps and Ion Trap Arrays”), was to use a much smaller number of ion traps in the array, but to provide individual electronics control for each individual ion trap.

One embodiment of the disclosed invention involves the ability to electronically configure an array of ion traps into “channels”, in which each channel is composed of one or more ion traps. In this embodiment, the individual ion traps comprising each channel are operated in parallel, with each channel functioning as a separate mass spectrometer.

Another embodiment of the disclosed invention involves the ability to characterize the performance of each individual ion trap in an ion trap array, and electronically exclude from operation any individual ion trap that has unacceptable performance.

Another embodiment of the disclosed invention involves the ability to control an array of ion traps by applying the supplemental AC waveform signal used for performing resonance ejection, mass isolation, and mass excitation, to only a single endcap in an array of cylindrical ion traps, or to only a single X axis plate in an array of rectilinear ion traps, or to only a single X axis electrode in an array of hyperbolic-shaped linear ion traps.

Another embodiment of the disclosed invention involves the ability to improve the sensitivity and resolution of an ion trap array by electronically configuring an array of ion traps into channels, and electronically adjusting the RF timing control of each channel to compensate for individual mass calibration variations in the ion traps, primarily due to the physical differences between individual mass analyzers.

Another embodiment of the disclosed invention involves the ability to electronically configure an array of ion traps into “channels”, in which each channel is capable of performing detection of a unique compound simultaneously with the other channels.

Another embodiment of the disclosed invention involves the ability to electronically maximize performance of the ion trap array by dynamically adjusting the RF drive frequency such that data acquisition will require the RF drive signal to scan to its maximum output voltage.

### BRIEF DESCRIPTION OF THE DRAWINGS

FIG. 1 shows the basic structure of a cylindrical ion trap (CIT). The CIT is a simplification of the three-dimensional Paul ion trap. It consists of a simple cylindrical ring electrode, and two disc-shaped endcaps instead of hyperbolic electrodes.

FIG. 2 shows the basic structure of a rectilinear ion trap (RIT). The RIT is a simplification of the two-dimensional hyperbolic electrode linear ion trap. It consists of four flat plate electrodes, and two flat plate endcaps, with an exit slit in both X axis electrodes instead of hyperbolic electrodes.

FIG. 3 shows the structure of an array of cylindrical ion traps. To simplify the display, not all the interconnecting conductors are shown. The primary goal of FIG. 3 is to show the relative alignment of the CITs and the connections required to operate the CIT array.

FIG. 4 shows the top view of an array of fifteen individual rectilinear ion traps. The RITs are situated in circular fashion around a centrally mounted ion detector, which is usually an electron multiplier, but could also be a combination dynode and electron multiplier, or any other charge sensitive detector.

FIG. 5 shows the structure of a single RIT extracted from an array of RITs. The RIT is assembled vertically on top of an insulating layer containing a large aperture, which in turn is mounted on top of a conductive layer of material.

FIG. 6 shows a single cylindrical ion trap and the electronics needed to control the CIT and operate it as a mass spectrometer.

FIG. 7 shows a single rectilinear ion trap and the electronics needed to control the RIT and operate it as a mass spectrometer.

FIG. 8 shows a schematic of a method of controlling an array of ten cylindrical ion traps, with four different RF voltage sources and four different supplemental signal sources. Each CIT has one endcap grounded, and the other endcap connected to a supplemental AC voltage source.

FIG. 9 shows a schematic of a method of controlling an array of ten cylindrical ion traps, using four different RF voltage sources and four different supplemental signal sources. The figure shows each CIT having both endcaps connected to a supplemental AC voltage signal source.

FIG. 10 shows a schematic of a method of controlling an array of ten rectilinear ion traps, with four different RF voltage sources, four different supplemental signal sources, four different front endcap DC voltages, and four different rear endcap DC voltage sources. The figure shows the RITs having the supplemental signal source connected to only one of the X axis electrodes.

FIG. 11 shows a schematic of a method of controlling an array of ten rectilinear ion traps, with four different RF voltage sources, four different supplemental signal sources, four different front endcap DC voltages, and four different rear endcap DC voltage sources. The figure shows the RITs having the supplemental signal source connected to both of the X axis electrodes.

FIG. 12 shows the scan function needed to acquire a mass spectrum from a cylindrical ion trap.

FIG. 13 shows the scan function needed to acquire a mass spectrum from a rectilinear ion trap.

FIG. 14 shows the scan function needed to acquire an MS/MS spectrum from a rectilinear ion trap.

FIG. 15 shows the scan function that is used to acquire MS/MS data for two different compounds simultaneously from a rectilinear ion trap array.

FIG. 16 shows an example of characterizing an RIT array of 16 RITs, and the organization of the 16 RITs into three different channels.

FIG. 17 shows the schematic of the switching system needed to electrically organize an array of ion traps into a collection of channels.

FIG. 18 shows the mechanical configuration of a linear ion trap comprising four hyperbolic-shaped electrodes and two endcaps.

### DETAILED DESCRIPTION OF THE INVENTION

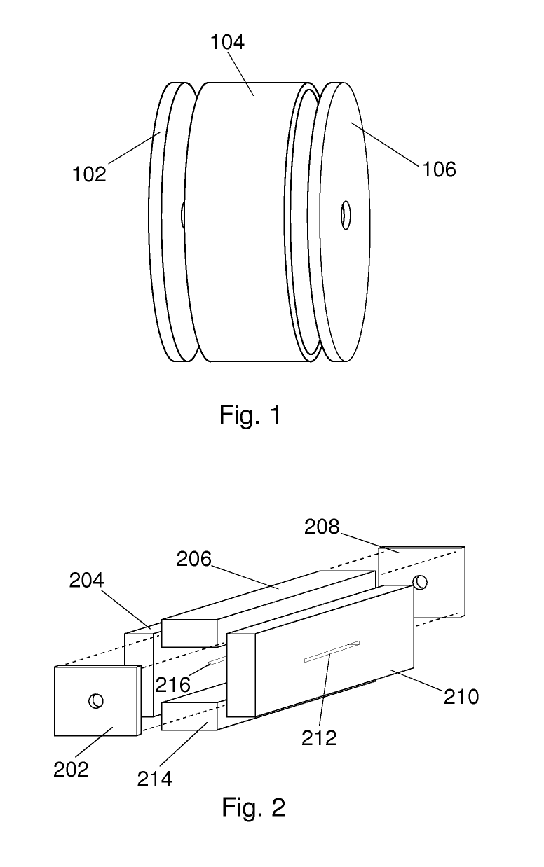

Efforts to miniaturize the mass analyzer, the mass spectrometer, and the development of the ion trap array, have been motivated by several factors. These include the ability to miniaturize the control electronics and vacuum components, the ability to operate ion traps at higher pressures, and the ability to shrink the mechanical structure of the ion trap itself. The cylindrical ion trap (CIT) analyzer comprises only three main components, as show in FIG. 1. The CIT comprises a central ring electrode 104, bounded on each end of the ring electrode by two endcaps, 102 and 106. Ions may be introduced into the CIT through one or both of the apertures in the endcaps 102 and 106, or alternatively, neutral sample molecules may be introduced into the CIT trapping volume and then ionized by injecting electrons, reactive neutral molecules, or other ionized chemical species into the CIT through one of the apertures in one of the endcaps 102, 106. Trapped ions are then ejected, and detected, through one or both of the apertures in the endcaps 102 and 106. (All drawing references have been numbered in a similar fashion. The last two digits of each reference number refers to the element number and the first one or two digits refers to the figure number where the element was first illustrated.)

The rectilinear ion trap (RIT) has a more complex structure than the CIT, but has the advantage of having a larger ion storage capacity than the CIT due to the ability of the RIT to trap ions in a line along the Z axis as opposed to a point, as is the case for the CIT and three dimensional Paul ion trap. However, the RIT still has a relatively simple geometric structure, as show in FIG. 2. The RIT consists of four flat rectangular plates, organized as a pair of plates in the X axis, 204 and 210, and a pair of plates in the Y axis, 214 and 206. The RIT is bounded on each side by two planar endcaps, 202 and 208. Ions are introduced into the RIT through one or both of the apertures located in the center of the endcaps 202 and 208. Trapped ions are then ejected, and detected, through one or both of the slits, 212 and 216, in the two X axis electrodes. Additionally, the RIT may be operated in such a manner that ions are ejected though the aperture in the rear endcap 208.

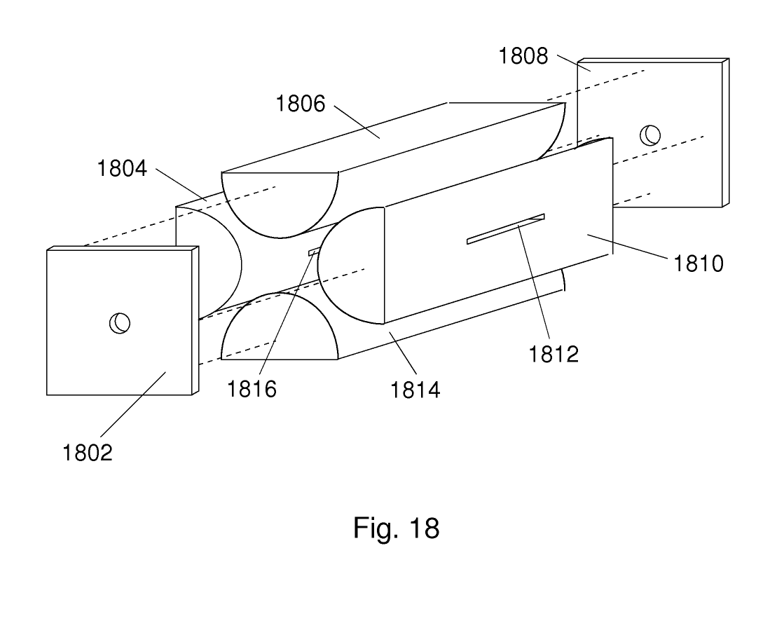

Although the CIT and the RIT have very simple mechanical structures, and are ideal for use in constructing miniaturized ion trap arrays, it is also possible to implement a miniaturized ion trap array with conventional hyperbolic shaped electrodes. FIG. 18 shows the basic mechanical construction of an ion trap constructed from four hyperbolic-shaped electrodes, shown at 1804, 1806, 1810 and 1814. The electrodes 1804 and 1810 are referred to as the X axis electrodes. The electrodes at 1806 and 1814 are referred to as the Y axis electrodes. The two endcaps are shown at 1802 and 1808. The endcap at 1802 represents the front endcap of the hyperbolic-shaped ion trap, also referred to as a Linear Ion Trap (LIT). Ions are injected into the LIT through the aperture in the front endcap 1802. Ions are ejected from the LIT during acquisition, and detected by a charge sensitive detector (typically an electron multiplier). The detected ions that constitute the mass spectrum are typically ejected radially through the apertures in the X axis electrodes at 1812 and 1816. Additionally, the LIT may be operated in such a manner that ions are ejected axially through the aperture in the rear endcap at 1808.

The discussion of ion trap arrays will normally involve arrays of cylindrical ion traps (CITs), rectilinear ion traps (RITs) or linear ion traps (LITs). However, it is also possible to combine a mixture of the three different types of ion traps and achieve the same cumulative results and advantages.

The hyperbolic-shaped electrodes that comprise the linear ion trap (LIT) provide for somewhat better performance in practice, although they are more difficult to manufacture. However, with respect to mechanical mounting and electrical control, the LIT is virtually identical to the RIT, and whenever reference is made to an RIT array, it is possible to extend the discussion, application and examples mentioned to an LIT array.

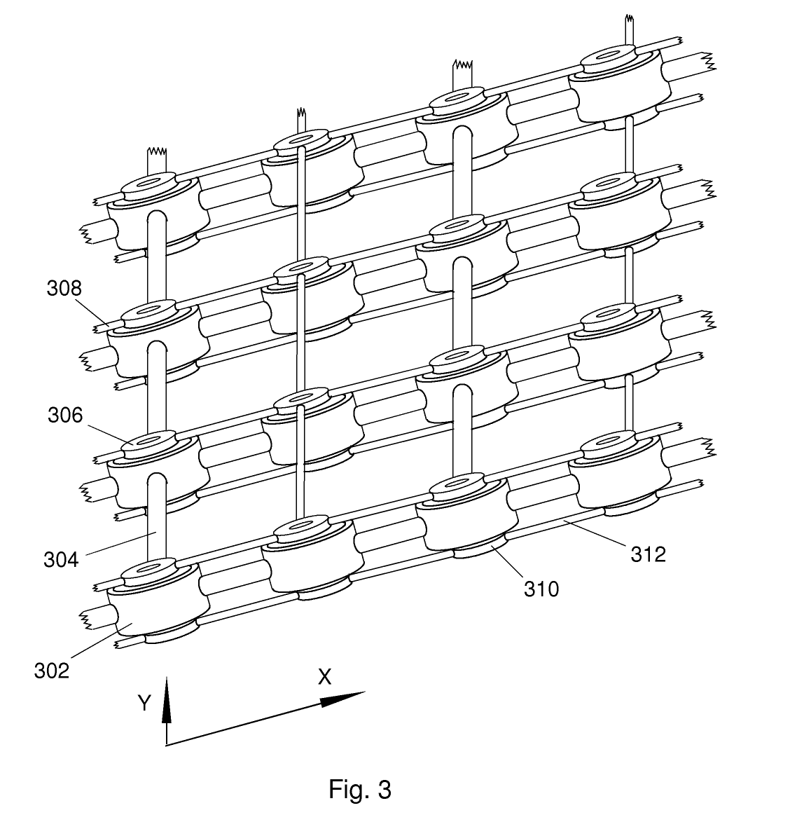

Owing to its simple mechanical structure, an array of CITs can be constructed in a variety of configurations. FIG. 3 shows an example of an array comprising sixteen identical CITs. Element 302 represents one of the ring electrodes of a CIT. Element 306 represents one endcap while element 310 represents the alternate endcap. For the array shown in FIG. 3, all of the electrodes of each CIT are connected in parallel. Element 304 shows a mechanical conductor that functions as both a mechanical support for the ring electrodes as well as the electrical conductor that connects all the ring electrodes in parallel. Element 308 shows a mechanical support, and electrical conductor, for all the endcaps on the top side of the array. Element 312 shows a mechanical support, and electrical conductor, for all the endcaps on the bottom side of the array.

FIG. 3 demonstrates only one of the many ways in which a CIT array could be constructed. To simplify the drawing, FIG. 3 does not show all the mechanical supports and conductors that could be used in a final design to obtain maximum mechanical strength, but it does show all the conductors that are necessary to electrically connect all the electrodes together in parallel. In addition, there are other mechanical designs that would also work effectively to construct a CIT array. The main requirement is to use a mechanical and electrical structure that would hold each CIT electrode securely with good electrical contact to each surrounding CIT.

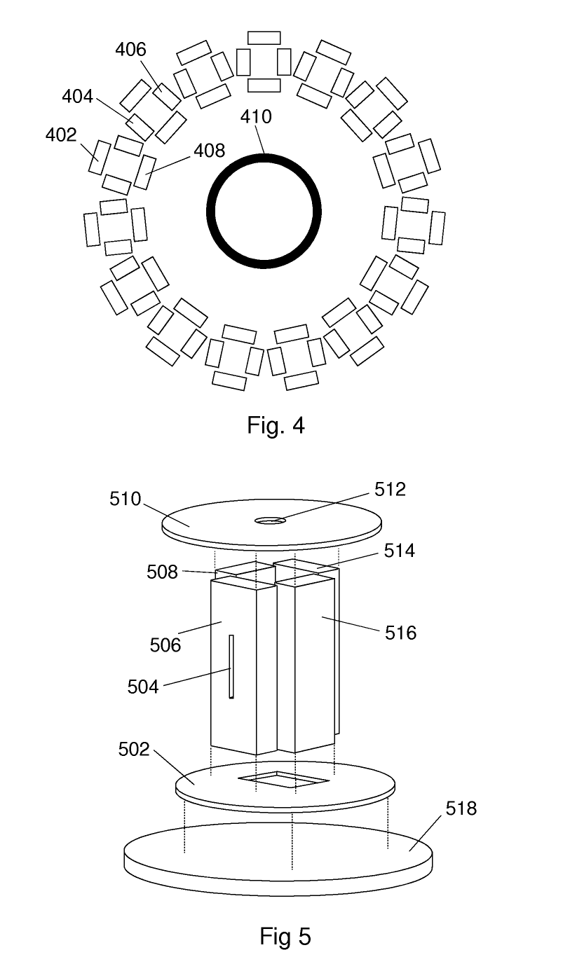

The construction of an array of rectilinear ion traps, as opposed to cylindrical ion traps, is understandably more complex. FIG. 4 shows the top view of an array of fifteen rectilinear ion traps arranged in a circular fashion around a single ion detector. Elements 402 and 408 represent the X axis electrodes. Elements 404 and 406 represent the Y axis electrodes. Element 410 represents the ion detector, which is typically an electron multiplier with a circular entrance aperture. It is also possible to construct an RIT array with a conversion dynode in conjunction with an electron multiplier, or an appropriate charge sensitive detector, such as a Faraday cup detector.

The structure of an individual RIT in an RIT array is shown in FIG. 5. The four planar electrodes comprising an RIT (elements 506, 508, 514 and 516) are mounted vertically on an insulating layer 502. The insulating layer must have an aperture at least as large as the inner rectangular area of the RIT. The insulating layer, which would typically be composed of a ceramic, or other insulating material, must be mounted onto a conductive layer, shown at 518. The conductive layer 518 could be composed of stainless steel, or any other conductive material that is chemically inert. The conductive layer 518 functions as one of the endcaps of the RIT.

On top of the RIT is another conductive plate 510 that functions as the other endcap for the RIT. This endcap 510 must be of a similar material as the alternate endcap 518. It should be stainless steel, or any other conductive material that is chemically inert. The endcap 510 must also have an aperture located in the center of the plate, as shown at 512. This aperture is used as the entrance for the ions to be analyzed by the RIT. Endcap 510 must be mounted in such a manner as to maintain a separation distance from the X and Y axis plates 506, 508, 514, 516 of the approximate separation distance of conductive layer 518 from the same X and Y axis plates. During the data acquisition phase, ions are ejected from the RIT through a slit in one of the X axis plates, shown at 504. Additionally, ions may be ejected through a slit placed into the X axis plate 514.

### Electronic Control of Ion Trap Arrays

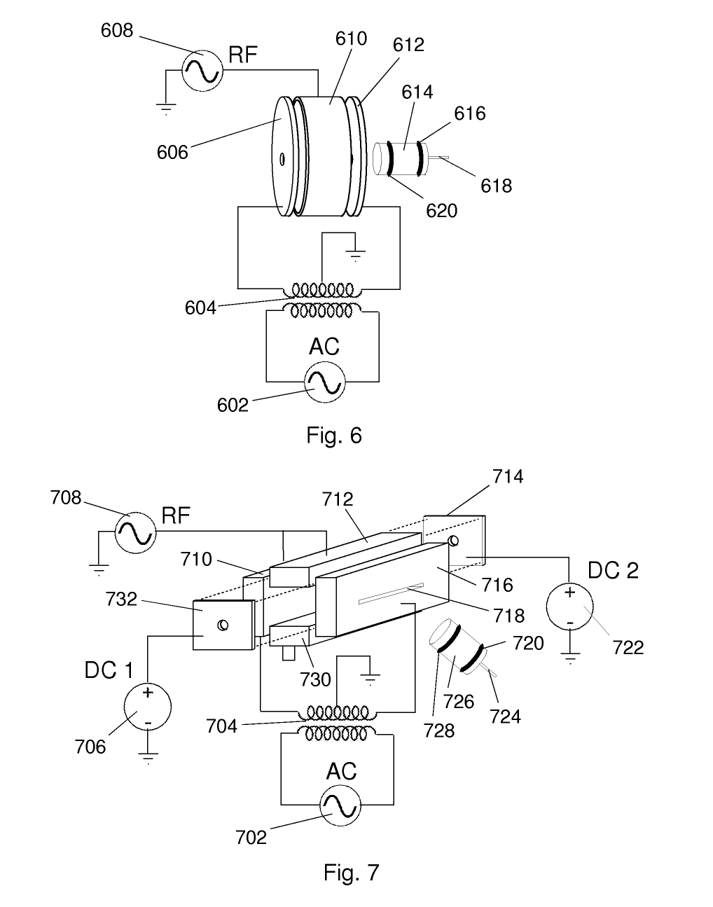

The electronics needed to control an individual CIT and an individual RIT are shown in FIGS. 6 and 7. They have several similarities, and generally any discussion of the electronics and control circuitry for the CIT also applies to control of the RIT, and vice versa. Additionally, any discussion of controlling an RIT also applies to control of an LIT, due to the similar geometry of the RIT and LIT.

The electronics needed to control a cylindrical ion trap are shown in FIG. 6. An RF voltage source 608 is connected to the ring electrode 610 of the CIT. A typical ion trap mass spectrometer having an internal radius in the range of several millimeters to one centimeter will typically require an RF voltage source generating a sine wave having a frequency of 500 kHz to 10 MHz and a peal-to-peak voltage ranging from a few hundred volts to 5000 volts or more. However, for a CIT array having an inner radius of 2 mm or less, acceptable performance can be obtained from an RF source supplying less than 500 volts. In this range, it becomes possible to construct an RF generator without a tuned RF step-up transformer. As a consequence, if a tuned RF step-up transformer is not used to control a miniaturized ion trap, it's possible to control both the voltage and the frequency of the RF drive signal.

The ability to change the frequency of the RF signal used to drive an ion trap, due to the lack of a tuned RF step-up transformer, allows the ion trap to be operated in a frequency scanning mode. In this embodiment, ions may be scanned out of the ion trap in successively increasing m/z values by decreasing the RF drive frequency while holding the RF trapping voltage constant. This allows for an almost unlimited mass range to be obtained from the ion trap, although with reduced sensitivity and reduced resolution, as described by Schlunegger et al. (“Frequency Scan for the Analysis of High Mass Ions Generated by Matrix-Assisted Laser Desorption/Ionization in a Paul Trap”).

In addition to the frequency scanning technique described by Schlunegger, it is also possible to sequentially eject ions from an array of ion traps by properly decreasing the frequency of the supplemental AC signal applied to the endcaps of each of the CITs, or by properly decreasing the frequency of the supplemental AC signal applied to either the X axis or Y axis electrodes of the RITs or LITs. This technique also has the advantage of allowing an almost unlimited mass acquisition range, while sacrificing sensitivity and resolution.

The endcaps of the CIT are shown as elements 606 and 612. The endcap 606 has an aperture in the center of the endcap. This aperture is used as the entrance port for sample ions. The alternate endcap 612 also has an aperture in the center. Ions are ejected from this aperture in 612 during the acquisition of data when the RF voltage is scanned. Ions ejected through the aperture in the endcap 612 are attracted to the ion detector, which is shown as an electron multiplier 614. The electron multiplier 614 has a high negative voltage source connected near its entrance aperture at 620. A ground connection is made to the electron multiplier at 616. During mass analysis, a very small electrical current is generated within the electron multiplier that is representative of the ion signal being acquired. This electrical current is sampled at point 618 on the electron multiplier and is amplified and recorded as the ion signal, representing the ion abundance of the acquired ions. This recorded ion signal is typically displayed, or processed, as the mass spectrum.

FIG. 6 shows a CIT used for detecting positive ions. In this mode, the electron multiplier 614 is operated with a negative voltage. It is also possible to use a dynode in conjunction with the electron multiplier. In this configuration, the dynode may be used to improve the sensitivity of the CIT mass spectrometer when operating in a positive ion mode, or alternatively it may be used to detect negative ions by applying a high positive voltage to the dynode during acquisition.

During normal acquisition from the CIT, the endcaps must be connected to an electric potential. They cannot be left floating, but they may both be grounded. However, a major improvement in sensitivity and resolution can be obtained through application of a resonance ejection signal, which is implemented by applying a specific frequency to the endcaps of the CIT in a bipolar fashion, as shown by the AC signal generator 602, which drives a wide-band transformer 604, generating a bipolar signal that is applied to the endcaps 606 and 612. The signal generated by the transformer 604 has the center-tap of its secondary winding grounded.

The frequency signal applied to the endcaps of the CIT is often referred to as a “resonance ejection” signal, as it matches the resonant frequency of the ions at the point at which they are ejected from the ion trap during an RF scan. Normally, this frequency will never be more than one-half the RF drive frequency, however, under specific circumstances higher order harmonics of the ion resonance frequency can be used as the resonance ejection signal. This signal is applied to the endcaps of the CIT during the time that the CIT is acquiring data, as described later during a discussion of the CIT scan function.

During an MS/MS experiment, two types of signals are applied to the endcaps of the CIT. One signal is a broad-band waveform that has certain frequency components removed, creating a “notched” broadband waveform used to resonantly eject all ions outside the notch, leaving only a “parent” ion species. Another signal is a narrow band frequency that is used to resonantly excite the previously isolated parent ion. This signal is used to induce fragmentation of the parent ion and create a “daughter” ion spectrum through collisions with neutral molecules.

The electronics needed to control a rectilinear ion trap is shown in FIG. 7. It is similar to the circuitry of FIG. 6, with some additions. The RF generator 708 must be able to generate a sine wave having a frequency of 500 kHz to 10 MHz. Just as it was for the CIT, a typical RIT mass spectrometer having an internal radius in the range of several millimeters to one centimeter will typically require an RF voltage source generating a sine wave having a peak-to-peak voltage in the range of hundreds of volts to 5000 volts or more. However, for an RIT array having an inner radius (r₀) of 2 mm or less, acceptable performance can be obtained from an RF source supplying less than 500 volts. In this range, it becomes possible to construct an RF generator without using a tuned RF step-up transformer. This provides the ability to control a miniaturized ion trap from an RF generator circuit that can employ control over both voltage and frequency.

The RF generator signal for the RIT in FIG. 7 is connected to both of the Y axis plates 712 and 730 of the RIT. The resonance ejection signal from the AC source 702, in a similar manner to the CIT, will normally generate a signal during data acquisition that will be less than one-half the RF generator frequency. The AC signal generated from the source at 702 drives a wide-band transformer at 704, whose output is connected to the X axis plates 710 and 716. The center-tap of the secondary winding of wide-band transformer 704 is grounded to provide a common ground reference for the resonance ejection signal.

Ions that are ejected from the RIT are ejected through the slit 718 in one of the X axis endcaps 716. The ejected ions are attracted to the electron multiplier at 726. The electrode at 728 on the electron multiplier 726 will typically be connected to a negative high voltage DC source, between 1000 and 3000 volts, for the detection of positive ions ejected from the RIT. The electron multiplier 726 will also have a ground connection made to the electrode at 720. The electron multiplier will generate an electrical current at point 724, which will be proportional to the ions that are ejected from the RIT. The electrical current signal generated at 724 will be amplified by a very high gain amplifier, and used as an indication of the mass spectrum acquired by the RIT analyzer.

In another embodiment of the invention, the previously described analyzer of FIG. 6 and FIG. 7 could include a separate conversion dynode in conjunction with the electron multiplier. In this configuration, the conversion dynode is placed in front of the electron multiplier and operated at a very high DC potential of several thousand volts or more. Ions strike the conversion dynode and generate secondary ions, which are then attracted to the electron multiplier. If the conversion dynode is operated with a negative voltage it will attract positive ions, and the electron multiplier will record a positive ion spectrum. If the conversion dynode is operated with a positive voltage, it will attract negative ions and the electron multiplier will record a negative ion spectrum. Additionally, the electron multiplier may be replaced with any suitable charge-sensitive detector.

One set of electronics control that is required by the RIT, but not the CIT, is the control of endcap voltages. The endcap voltages are DC voltages, and are normally held at a positive potential when trapping positive ions. Likewise, the endcap voltages are normally held at a negative potential when trapping negative ions. The DC 1 voltage source 706 connects to the RIT front endcap 732. The DC 2 voltage source 722 connects to the RIT rear endcap 714. Ions are injected into the RIT through the aperture in the front endcap 732. Ions are ejected from the RIT through the slit 718 in the X axis plate 716.

During ion injection into an RIT, such as the one shown in FIG. 7, the injected ions must possess sufficient energy to enter the RIT and remain trapped. This requires the creation of a potential well which serves to hold the ions along the central axis of the RIT. Normally, during injection of positive ions into an RIT, the front endcap 732 must be maintained at a slightly positive potential of several volts DC. During this injection time the rear endcap must also be maintained at a slightly positive DC voltage. After the ion injection phase has elapsed, both front endcap 732 and rear endcap 714 can be brought to a higher positive voltage, such as 10 or 20 volts DC, to enable reliable trapping of the injected ions. More detail on this subject is presented later during a discussion of the scan functions used to control the CIT and the RIT.

### Techniques of Controlling CIT and RIT Arrays

The development of a mass spectrometer utilizing an array of ion traps has typically comprised an array of either cylindrical ion traps (CITs) or rectilinear ion traps (RITs), controlled in one of two ways. One typical approach has been to electrically connect all the ion traps in the array in parallel. This configuration uses a single ion source and a single ion detector. In this configuration, the array functions as if it were a single mass analyzer

A second approach has been to create an array of rectilinear ion traps (RITs) that are individually controlled through separate electronic circuits. This configuration typically incorporates a separate ion detector for each ion trap, or uses just one detector with the ion traps arranged in a circular fashion around the single detector. The use of dedicated electronics for each individual ion trap allows each ion trap to be operated separately, and has many potential advantages, but the number of ion traps in the array is limited by the quantity of electronics dedicated to controlling each of the individual ion traps.

One embodiment of the disclosed invention comprises an improved technique for controlling an array of ion traps by electronically configuring the ion trap array into “channels”, in which each channel is composed of one or more ion traps connected in parallel and having the ability to dynamically adjust the number and set of ion traps comprising each channel.

As an example, if an RIT array comprises 60 individual ion traps, it could be electronically configured to function as a single channel of 60 RITs, or two channels of 30 RITs, or three channels of 20 RITs, etc. Further, the electronic control allows each channel to comprise any set of individual ion traps. Therefore, as a further example, if each channel comprised 20 RITs, each set of 20 RITs could be selected from any of the original 60 RITs in the original ion trap array.

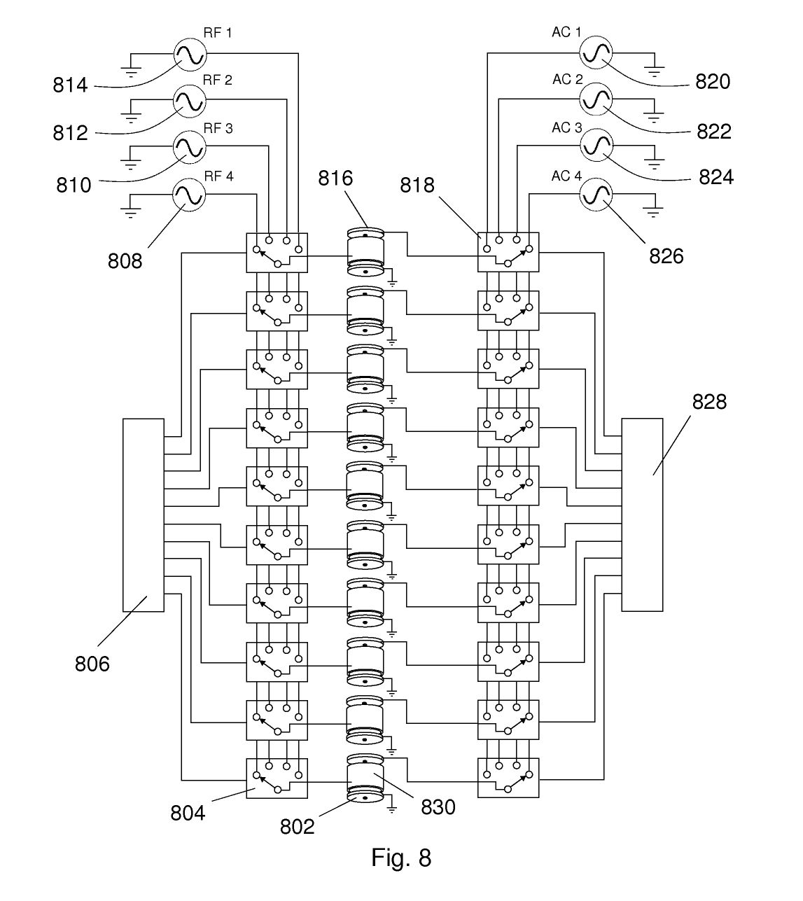

FIG. 8 shows an example of a method of configuring an array of 10 CITs, such that they may be operated as a collection of ion traps comprising from one to four channels. The analog switch 804, which is duplicated for each of the 10 CITs, allows any of the four RF generators, 808, 810, 812, 814, to be connected to any combination of the 10 CITs. The selected RF signal connects to the ring electrode 830 of each of the CITs.

In a similar fashion, the analog switch 818, which is duplicated for each of the 10 CITs, allows any of the four auxiliary AC signal generators, 820, 822, 824, 826, to be connected to any combination of the 10 CITs. The selected AC signal connects to one endcap 816 of each of the CITs. The other endcap 802 of each CIT is connected to ground.

FIG. 8 also shows two control modules, 806 and 828 that are used to control the analog switches, 804 and 818. Modules 806 and 828 could typically be constructed from a serial-to-parallel conversion device that would accept a serial input stream, which represents the desired state of the analog switches, and then sets the parallel output values that are used to control the state of the analog switches.

Another embodiment of the invention is the manner in which the supplemental AC signals are applied to the individual CITs. The control system shown is capable of effectively controlling the CIT array by applying the supplemental AC signal to only one endcap of each ion trap. Prior art implementations of electronics used to control miniaturized ion trap arrays routinely required both endcaps to be connected to the supplemental AC signal in a bipolar fashion. The Ouyang patent (U.S. Pat. No. 6,838,666) specifically describes the application of the supplemental signal to both X axis plates in each RIT of an RIT array, and in the claims also requires the signal to be applied to “at least one pair” of the X and Y electrodes. However, the circuitry shown in FIG. 8 permits the ion trap array to be operated by applying the supplemental AC signal to only one endcap 816 on each of the ion traps. This configuration requires the other endcap 802 to be connected to a ground potential. This not only simplifies the electrical control of the ion trap array, but also permits the CITs in the ion trap array to be mechanically connected to a grounded surface that could also be used as a mechanical support for the ion trap array.

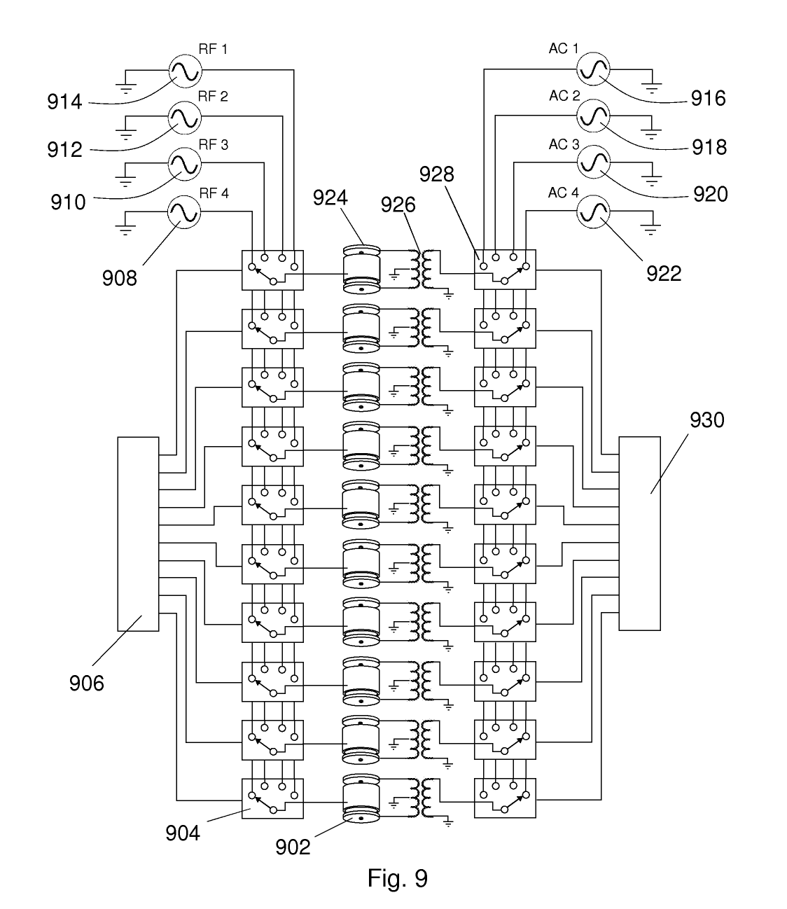

FIG. 9 illustrates a method of controlling an array of 10 CITs that requires the connection of a supplemental AC source to both endcaps of each CIT through use of a wide-band transformer 926. This is not as efficient as the technique displayed in FIG. 8, and does not allow the use of a mechanical ground support to be attached to one of the endcaps.

The remaining circuitry shown in FIG. 9 is the same as that described in FIG. 8. The analog switches 904 are used to select which RF signal source 908, 910, 912, 914 will be connected to each of the CITs. The analog switches 928 are used to select which supplemental AC signal source 916, 918, 920, 922 will be connected to each of the CITs. The controller devices 906 and 930 are used to permit a digital controller to set the analog switches to the desired state.

The circuitry used to apply the supplemental AC signal to the CITs, as shown in FIG. 8, is simpler and more efficient than the circuitry shown in FIG. 9. However, the supplemental signal applied to the endcaps 816, as shown in FIG. 8, must be applied using twice the amplitude as the signal applied to the endcaps 902 and 924, as shown in FIG. 9.

An array of rectilinear ion traps is controlled in a similar fashion to that of an array of CITs. However, there are some major differences. The RF signal applied to the ring electrode of a CIT must be applied to both Y axis plates of an RIT, such as is shown in FIG. 7, elements 712 and 730. The RF signal could, optionally, also be applied to both X and Y axis plates in a bipolar fashion. The supplemental AC signal applied to the endcaps of a CIT must be applied to the Y axis plates of an RIT, as is shown in FIG. 7, elements 710 and 716.

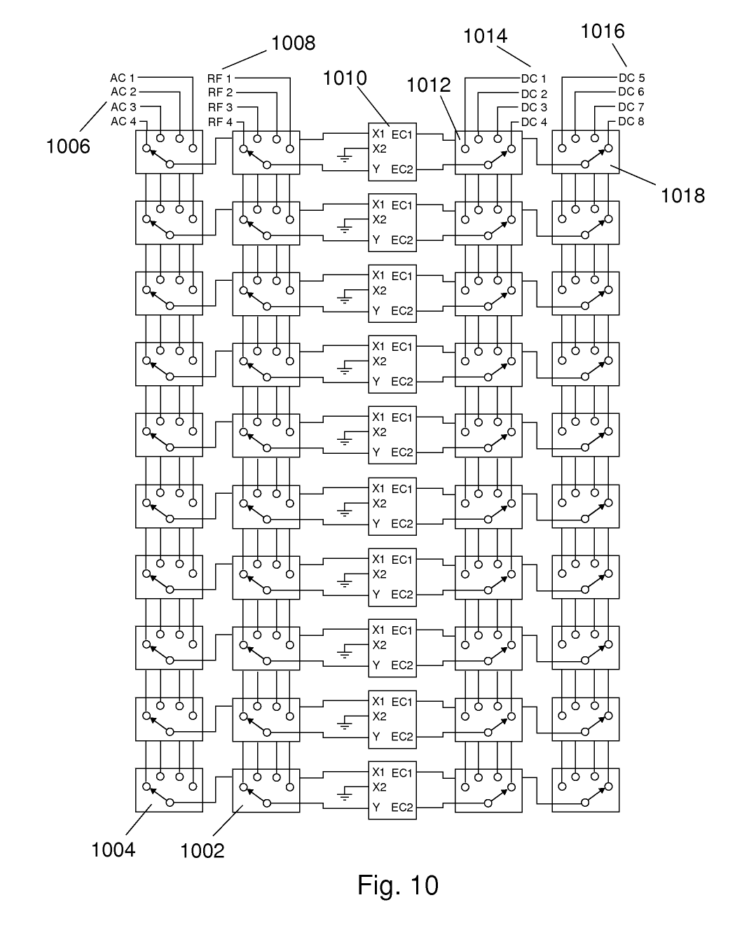

An illustration for a technique to control an array of 10 RITs from 4 different sets of electronics is shown in FIG. 10. The individual RITs are shown as device 1010. To simplify the drawing, the 1010 devices are each shown as boxes, with each of the boxes representing an individual rectilinear ion trap (RIT). Each of the RITs has five electrical connections that must be made. There are two connections for the X axis plates, one connection to the Y axis plates that are electrically connected together, and two connections for the DC potentials that must be applied to the endcaps of the RIT.

The 4 different RF signals that may be used to control the RITs are shown in FIG. 10 at 1008. These are designated RF 1, RF 2, RF 3 and RF 4. Each of the RITs, shown by the symbol at 1010, can select the desired RF signal with its corresponding analog switch 1002. The selected RF will then be connected to the RIT 1010 at the input terminal labeled Y. This terminal connects directly to both of the Y axis plates comprising the RIT, and is shown in FIG. 7 as plates 712 and 730.

In a similar fashion to the four RF potentials, the supplemental AC signal may be selected from the four different AC signals shown at 1006, and designated AC 1, AC 2, AC 3, and AC 4. Each of the RITs 1010 may select the desired supplemental AC signal with its corresponding analog switch 1004. The selected supplemental AC signal will be connected to the RIT 1010 at the input terminal labeled X1. The X1 terminal connects to one of the X axis plates, as is shown in FIG. 7 at 716. The other X axis plate is designated on the RIT 1010 in FIG. 10 as X2, and is shown in FIG. 7 at 710. The X2 terminal for the configuration shown in FIG. 10 must be connected to ground potential.

Each RIT also needs to have its two endcaps controlled by application of an appropriate DC voltage level (as will be described in more detail during a discussion of the ion trap scanning functions). The four different DC voltages that can be connected to the front endcap are shown at 1016 in FIG. 10, and are designated DC 5, DC 6, DC 7 and DC 8. The RIT 1010 can select the desired front endcap voltage through appropriate control of the analog switch 1018. The selected DC voltage will be connected to the RIT at the terminal designated EC1 on the RIT 1010. The front endcap of an RIT is shown in FIG. 7 at 732. In a similar fashion, the DC potential for the rear endcap is selected from one of the four DC potentials shown at 1014, and designated DC 1, DC 2, DC 3 and DC 4. Each RIT may select the desired DC potential for the rear endcap by setting the analog switch 1012 appropriately. The DC potential selected by one of the analog switches 1012 is connected to the rear endcap through the terminal on RIT 1010 designated as EC2. The rear endcap of an RIT is shown in FIG. 7 at 714.

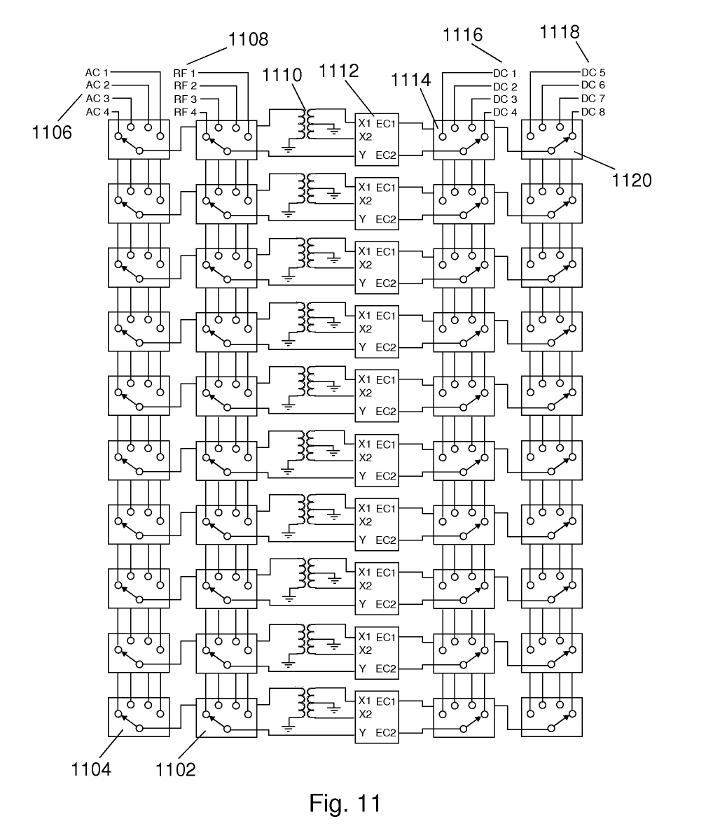

FIG. 11 shows a similar approach taken to control an array of 10 RITs 1112, organized in such a fashion that it could create up to 4 different mass spectrometer channels. As with FIG. 10, to simplify the drawing, the 1112 devices are each shown as boxes, with each of the boxes representing an individual rectilinear ion trap (RIT). The RF signals that can be selected are shown at 1108, and selected through one of the analog switches 1102. The four different supplemental AC signals that can be selected are shown at 1106, and selected through one of the analog switches 1104. The DC voltages that can be selected to control the front endcap are shown at 1118, and selected through one of the analog switches 1120. The DC voltages that can be selected to control the rear endcap are shown at 1116, and are selected through one of the analog switches 1114.

Unlike the circuit shown in FIG. 10, in which the supplemental AC signal is connected to only one of the X axis plates, the design shown in FIG. 11 requires the supplemental AC signal to be connected as a bipolar signal to both of the X axis plates. This is accomplished through use of the wide-band transformer 1110, in which the supplemental signal is connected to one side of the primary, with the other side of the primary grounded. The secondary of the wide-band transformer 1110 has one side connected to X1, which is one of the X axis plates, as shown in FIG. 7 at 716. The other side of the secondary of the wide-band transformer 1110 is connected to X2, which is the other X axis plate, and shown in FIG. 7 at 710. The center tap of the secondary winding of each of the wide-band transformers 1110, is grounded.

One embodiment of the disclosed invention, as shown in FIG. 8 and FIG. 10, can now be seen to have the advantage of having less electronics, and an ability to connect one of the endcaps (in the case of a CIT array), or one of the X axis plates (in the case of an RIT array) to a mechanical ground connection. In addition, the embodiment shown in FIG. 8 and FIG. 10 does not require use of a broad-band transformer. The typical broad-band transformer does not have a flat frequency response, and the use of a broad-band transformer in conjunction with the supplemental AC signal can lead to degraded performance when the supplemental AC signal is a complex notched waveform, as is used to perform mass isolation.

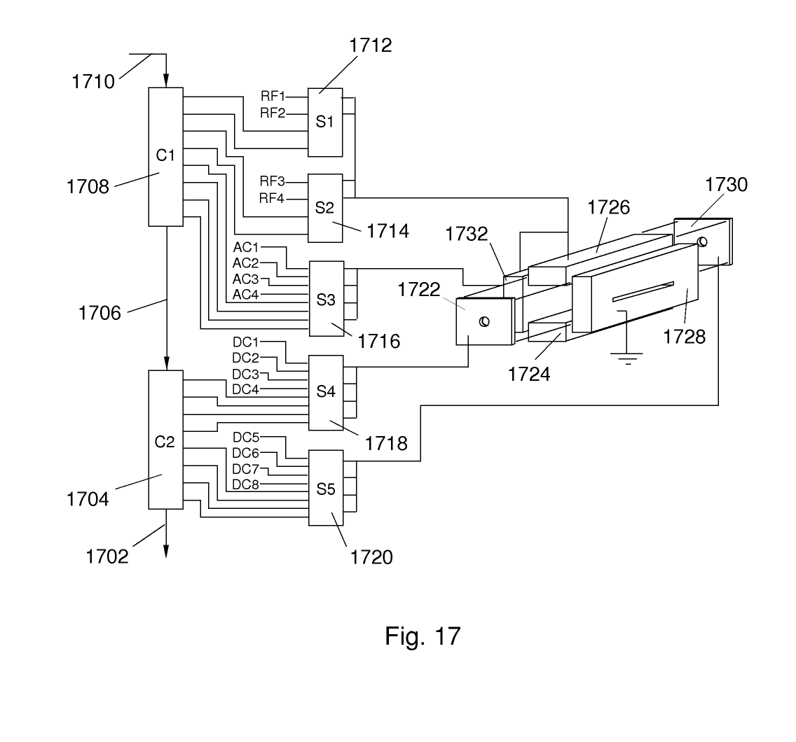

A more detailed description of the electronics needed to control the ion trap arrays shown in FIGS. 8, 9, 10 and 11, is shown in FIG. 17. The serial bit stream that controls which signal sources should be connected to each individual ion trap is shown in FIG. 17 at 1710. The input connects to a serial-to-parallel converter C1 1708. There are many serial-to-parallel converters that could be used, but an acceptable option is the SN74AHC594 8-bit shift register from Texas Instruments, which can be cascaded to produce any length of serial-to-parallel conversion.

FIG. 17 shows the serial bit stream defining the analog switch positions entering the C1 serial-to-parallel converter 1708, and cascaded from the C1 converter 1708, through the output of C1 1706, to the C2 converter 1704, which is a duplicate of the C1 chip. The output bit stream is also shown exiting from C2 at 1702 and is available for the next serial-to-parallel converter.

FIG. 17 shows a dual analog switch S1 1712, and a dual analog switch S2 1714, that are used to select one of the four RF signal sources, shown as RF1, RF2, RF3, and RF4. Both S1 1712 and S2 1714 are high voltage analog switches that are used to select one of the RF signal sources to connect to the rectilinear ion trap at the Y axis electrodes 1726 and 1724. There are many analog switches that would be acceptable for this function. However, for a miniaturized ion trap array, where the RF peak-to-peak voltage is less than 500 volts, S1 and S2 could be implemented by using two Vishay LH1526AB dual solid-state relays.

FIG. 17 shows three quad analog switches at S3 1716, S4 1718 and S5 1720. The quad switch at S3 1716 is used to select one of the four supplemental AC signals, shown as AC1, AC2, AC3 and AC4, to one of the X axis plates at 1732. The other X axis plate 1728 is connected to ground. The quad switch at S4 1718 is used to select one of the four DC signals, shown as DC1, DC2, DC3, and DC4, to the front endcap at 1722. The quad switch at S5 1720, is used to select one of the four DC signals, shown as DC5, DC6, DC7 and DC8, to the rear endcap at 1730. There are many ways to implement the quad switches of S3, S4 and S5, but an acceptable approach is to use three ADG5412W quad SPST switches from Analog Devices.

The described methods of controlling the individual ion traps, such as illustrated in FIG. 6 through FIG. 11, and FIG. 17, has involved the application of a single RF potential to the ring electrode of the CIT, or to the X axis electrodes of the RIT or LIT. However, it is also possible to control an RIT or LIT through application of a bipolar RF signal. When controlling an RIT or LIT with a bipolar RF signal, one polarity of the RF signal is connected to the X axis electrodes, and the other polarity is connected to the Y axis electrodes. This bipolar configuration is well understood in the field and has the advantage of improved ion injection efficiency and a reduced peak-to-peak voltage output required by the RF generator.

In addition, the described methods of controlling the individual ion traps has involved the use of a symmetrical RF signal, having no DC potential between the X and Y electrodes of the ion trapping devices. However, it is also possible to operate the ion traps through such an application of a DC potential to the ion trap electrodes. This approach is also well understood in the field, and effectively changes the stability diagram and operating region of the ion trap, but may also offer some advantages in operational performance.

### Ion Trap Array Scan Functions

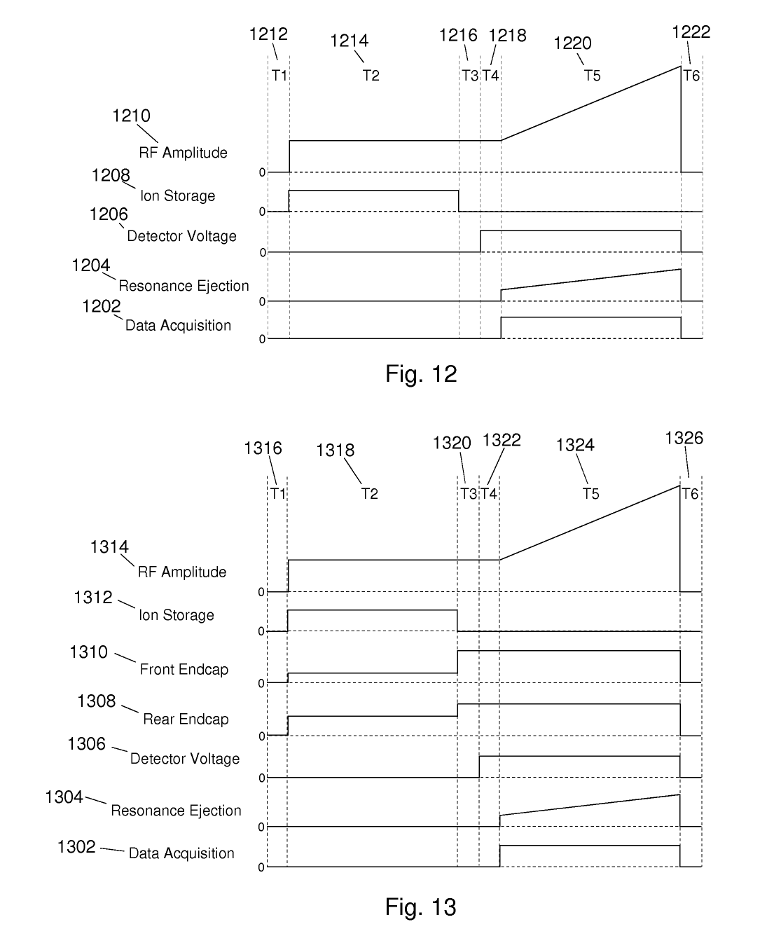

The exact manner by which individual ion traps in an ion trap array must be controlled is typically illustrated through use of a scan function in which the amplitude and timing of each parameter is displayed. A simple scan function that can be used to acquire data from a single cylindrical ion trap is shown in FIG. 12. The parameters that must be controlled are listed on the left side of the plot. The relative amplitudes of the parameters are shown on the plot as a function of time. Each significant portion of the scan function is defined with one time segment, designated as T1, T2, etc. at the top of the plot.

The amplitude of the RF signal is shown in FIG. 12 at 1210. During the first time interval T1 1212, the electronics must be enabled and ready to operate. Depending on the electronics design, this will typically be very short, and on the order of a few milliseconds or less. The next time segment T2 1214, will be used to store ions in the CIT. The second parameter is designated “Ion Storage” 1208 and is used to indicate when ion storage should occur. For a CIT this will correspond to the activation of the ion source, which will provide a supply of sample ions directed into the aperture of the entrance endcap of the CIT, as shown in FIG. 6, element 606. During this time, ions are injected into the CIT, and the presence of the RF signal during this time period will serve to hold the injected ions in the trap.

The next time segment, T3 1216 is reserved for the ion cooling time. During this time period, the ion injection must be disabled, and the RF signal must remain. This time period, which is normally only a few milliseconds, is used to permit the trapped ions to become kinetically cooled and to coalesce into the center of the CIT volume in preparation for the ions to be scanned out of the ion trap.

The next segment, T4 1218 is used to enable the detector voltage. This is also shown as the third parameter on the scan function plot as “Detector Voltage” 1206. The ion detector is typically an electron multiplier which operates with a voltage of from 1000 to 3000 volts DC or more, having a negative potential for detecting positive ions. Normally, the high voltage supply will require some period of time to come up to operating potential, and this will be the time designated as T4 1218. Depending upon the electron multiplier supply, this time period could range from a few microseconds to several milliseconds. The T4 time period used to enable the multiplier also contributes to the ion cooling time, so it is possible to combine both T3 and T4.

At the beginning of the T5 1220 time period, the ion trap will be ready to acquire data by scanning ions out of the ion trap. This is accomplished by increasing the amplitude of the RF signal, which will eject the trapped ions in increasing order of their mass-to-charge (m/z) ratios. This mode of operation of an ion trap is referred to as “mass selective instability scanning”. During this time, the ion signal generated by the electron multiplier, as shown in FIG. 6 at 614, will generate an ion signal that represents the mass spectrum of the injected compound. The bottom plot in the scan function of FIG. 12 at 1202, labeled “Data Acquisition”, displays the time during which data will be acquired and recorded from the electron multiplier.

The scan function of FIG. 12 also shows, at 1204, a parameter named “Resonance Ejection”. This represents the amplitude of the supplemental AC signal that will be applied to the endcaps of the CIT during RF scanning to improve the resolution of the acquired data. As discussed earlier, the frequency of this supplemental AC signal is normally less than one-half of the RF drive frequency. The amplitude of the resonance ejection signal is normally small, having an amplitude that will typically be on the order of tens of volts peak-to-peak for an ion trap with an r₀ of 1 cm, with voltage amplitudes proportionately less for ion traps having smaller r₀ dimensions. In addition, performance can be enhanced if the amplitude of the resonance ejection signal is also increased in a linear manner as the RF amplitude is increased. The plot at 1204, in FIG. 12, illustrates the manner in which the resonance ejection signal should be increased during the acquisition phase of the scan function. The resonance ejection waveform will normally vary from a low of 2 or 3 volts peak-to-peak at the beginning of the scan, up to a maximum of 10 or 20 volts peak-to-peak at the end of a full mass range scan for an ion trap with an r₀ of 1 cm, with lower amplitude voltages needed for ion traps having smaller r₀ dimensions.

The last time period in the scan function of FIG. 12 is labeled T6 1222. This time period is normally very short, and typically lasts for only a few milliseconds or less. During this time period, the RF signal drops to zero to permit all trapped ions to obtain unstable trajectories and exit the ion trap. The T6 time period is also used to set up initial conditions to acquire the next scan of data.

FIG. 13 is used to show the scan function needed to control a rectilinear ion trap. The scan function for the RIT is similar to that of the CIT, showing the same six time periods, T1 1316, T2 1318, T3 1320, T4 1322, T5 1324, T6 1326, but with the addition of parameters needed to control the front endcap and the rear endcap. The scan function in FIG. 13 shows the RF amplitude plot at 1314, the ion storage time at 1312, the detector voltage signal at 1306, the resonance ejection signal at 1304, and the data acquisition signal at 1302. In addition, the “Front Endcap” signal is shown at 1310 and the “Rear Endcap” signal is shown at 1308.

The front endcap signal should remain at a very low voltage, typically 1 or 2 volts DC, during the ion storage time. This low DC voltage, which should be positive for the storage of positive ions, provides a small potential barrier for the injected ions to overcome before entry into the ion trap. After the ions enter the ion trap, they will lose some energy due to collisions with the neutral molecules present within the analyzer and will be trapped in the potential well created within the ion trap by the RF signal and the DC endcaps. After the ion storage time has elapsed, the front endcap potential should be increased to deepen the DC potential well holding the ions in the ion trap in the axial, or z, dimension.

In a similar manner, the rear endcap potential, shown at 1308, should be held at a slightly higher DC potential than the front endcap 1310 during ion injection, and then raised to an even higher potential after ion storage is complete to effectively trap the injected ions in the potential well created by the RF signal applied to the RIT and the DC voltages applied to the front and rear endcaps.

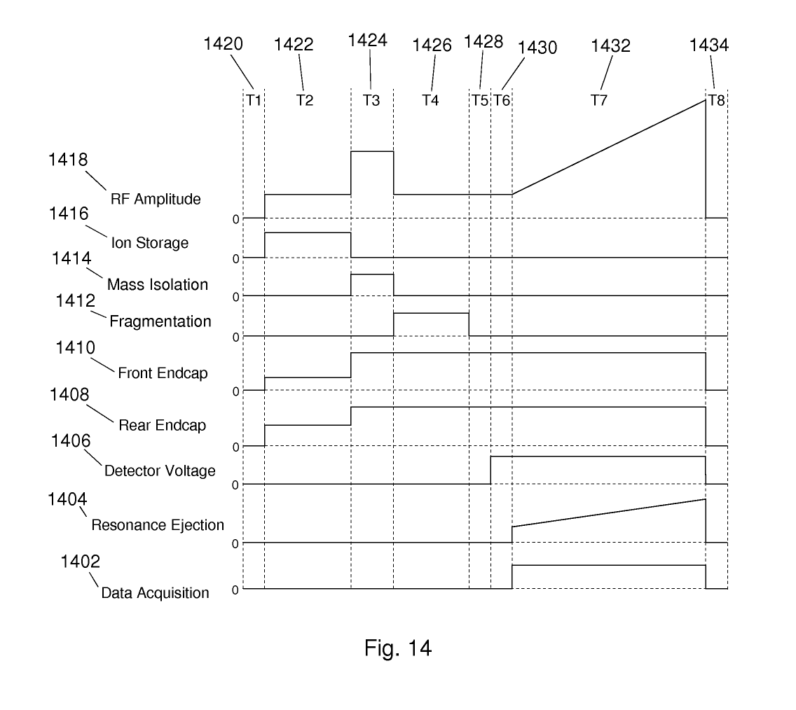

FIG. 14 shows the scan function needed to perform an MS/MS analysis with a rectilinear ion trap. The use of MS/MS allows a mass spectrometer to identify a particular compound when it is simultaneously present with other compounds. The MS/MS process requires that the mass spectrometer be capable of first isolating the molecular ion of the target compound, with all other ion species removed from the instrument. The next step requires that the mass spectrometer fragment the isolated molecular ion and generate a representative “daughter” spectrum. The presence of the molecular ion, and a match of the daughter ion spectrum with a previously recorded daughter ion spectrum for a target compound, is used as confirmation of the presence of the target compound.

One feature of the ion trap mass spectrometer is its ability to perform MS/MS without requiring multiple analyzers. An MS/MS scan function for an RIT is displayed in FIG. 14. The scan function of FIG. 14 includes two additional parameters not previously shown in the scan functions of FIG. 12 or FIG. 13. These are the “Mass Isolation” 1414 and the “Fragmentation” 1412 parameters. The other parameters have the same function as that described in the scan function of FIG. 13. These parameters are “RF Amplitude” 1418, “Ion Storage” 1416, “Front Endcap” 1410, “Rear Endcap” 1408, “Detector Voltage” 1406, “Resonance Ejection” 1404, and “Data Acquisition” 1402.

The scan function of FIG. 14 begins with the initial setup time T0 1420, and then enables the RF trapping potential for ion injection and trapping during time period T2 1422. Then, during the mass isolation step of T3 1424, a mass isolation waveform will be applied to the endcaps of the X axis plates of the RIT. The mass isolation waveform is a “notched” broadband waveform with notches (no frequency components) placed at particular trapped ion frequencies. When this broadband isolation waveform is applied to the X axis plates of the RIT, it will resonantly excite and eject all unwanted ions from the ion trap, leaving only the selected m/z ion to be analyzed. The mass isolation waveform is normally applied for a few milliseconds, depending upon the amplitude of the isolation waveform itself. As the amplitude of the isolation waveform is increased, the time during which it is applied may be reduced. The most efficient result is normally achieved through experimentation by balancing the amplitude of the isolation waveform with the time duration of the isolation waveform.

During the mass isolation step T3 1424, the RF amplitude is often increased, as shown in the parameter plot for RF Amplitude 1418. The increase in the RF amplitude will shift the resonant frequencies of the trapped ions upward in frequency, and also spread the frequencies apart. This makes it easier to isolate an individual ion species using a notched broadband waveform without losing intensity of the isolated ion. Then, after the isolation step is complete, the RF amplitude must be restored to the initial trapping level that it had during the initial ion storage time T2 1422.

The “Fragmentation” 1412 step of the MS/MS function occurs during time period T4 1426. During this time, an excitation waveform is applied to the X axis electrodes of the RIT. The excitation waveform corresponds to the resonant frequency of the trapped parent ion in the ion trap. When this waveform is applied, it excites the selected ions that had previously been isolated, and causes the orbit of the molecular ions to increase, subjecting them to increased collisions at higher energy with the neutral molecules present inside the ion trap analyzer. These increased collisions serve to fragment the parent ion and generate a characteristic daughter ion spectrum that can be used for compound identification.

The method of application of the excitation waveform to the trapped parent ion is critical to the generation of a representative daughter ion spectrum. If the amplitude of the excitation waveform is too low, then no fragmentation will be produced. If the amplitude of the excitation waveform is too high, then all of the parent ions will be ejected from the ion trap and will not produce a daughter ion spectrum. Therefore, it often is required that experimentation be done to arrive at an optimum amplitude and time for the excitation waveform to be applied in order to achieve the most effective conversion of parent ions to daughter ions.

The remaining portion of the scan function of FIG. 14 is identical to the previous scan functions described. After the fragmentation step of T4, a cooling time T5 1428, is applied to permit the ions to coalesce into the center of the RIT. After that the electron multiplier voltage is enabled during time period T6 1430. Next, the trapped ions are scanned out of the ion trap during T7 1432 and detected externally, generating the resultant mass spectrum. At the end of the scan function, the RF amplitude is removed and all ions are ejected from the ion trap during T8 1434.

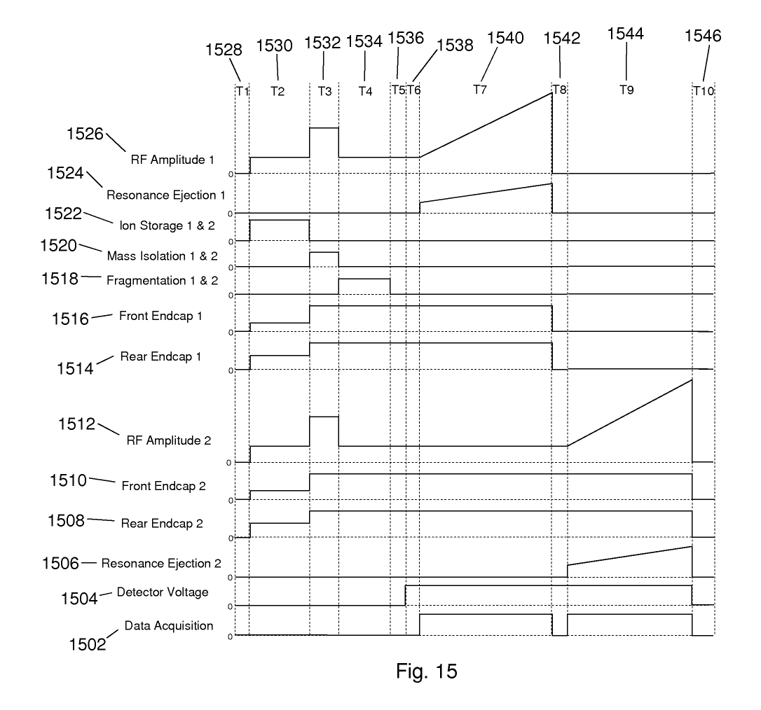

As previously discussed, one embodiment of the disclosed invention allows an array of ion traps to be organized into a varying number of channels, in which each channel comprises one or more individual ion traps operated in parallel. This would allow an ion trap array to simultaneously detect more than one compound at a time. FIG. 15 shows an example of a scan function that could be used to simultaneously detect two different compounds. This scan function operates on an ion trap array that has been organized electronically into two separate channels.

The scan function of FIG. 15 shows all the major parameters needed to control an ion trap array organized into two channels and capable of simultaneously detecting two different compounds with MS/MS analysis. The “RF Amplitude 1” parameter 1526 displays the RF signal amplitude of all ion traps that are connected to channel 1. The “RF Amplitude 2” parameter 1512 displays the RF signal amplitude of all ion traps that are connected to channel 2. The “Front Endcap 1” parameter 1516 displays the DC voltage amplitude of all ion traps connected to channel 1. The “Front Endcap 2” parameter 1510 displays the DC voltage amplitude of all ion traps connected to channel 2. The “Rear Endcap 1” parameter 1514 displays the DC voltage amplitude of all ion traps connected to channel 1. The “Rear Endcap 2” parameter 1508 displays the DC voltage amplitude of all ion traps connected to channel 2. The “Ion Storage 1 & 2” parameter 1522 displays the time during which ions will be injected into all ion traps of both channels.

While the ion trap array may be organized into different channels, there is only one ion source supplying sample to the mass spectrometer array, and there is only one ion detector being used. As such, the “Mass Isolation 1 & 2” parameter 1520 is also the time used for isolating the parent ion for both compounds being detected. Although the mass isolation times as shown in FIG. 15 during the T3 1532 time period are the same for both channels, these two time periods could actually be different for each channel. The mass isolation time periods for the two channels are shown to be the same to simplify the display of the scan function. In a similar fashion, although the “Fragmentation 1 & 2” parameter 1518 are shown to have the same start and end times for both channels, each channel may have a different start and end time.

Additionally, it would be possible to use the basic scan function described in FIG. 15 to acquire mass spectra of both positive ions and negative ions. In this configuration, the ion detector would comprise both an electron multiplier and a dynode. The first scan would acquire positive ions by operating the dynode with a negative voltage, and the second scan would acquire negative ions by operating the dynode with a positive voltage.

The two channel MS/MS scan function of FIG. 15 is significantly more involved than the MS/MS scan function displayed in FIG. 14, but it has the same main components. The scan function starts with all parameters at zero potential using time period T1 1528. The next step brings both RF Amplitude 1 1526 and RF Amplitude 2 1512 up to a level high enough to trap the injected ions without removing any low mass ions that might be of analytical interest. During this T2 1530 time period, ions are injected into all the individual ion traps comprising both channel 1 and channel 2. This is facilitated by setting the Front Endcap 1 parameter 1516 and the Front Endcap 2 parameter 1510 to a very low positive voltage, of 1 or 2 volts DC. The Rear Endcap 1 parameter 1514 and the Rear Endcap 2 parameter 1508 also need to be set to a positive DC potential during the T2 1530 ion storage time. Although the scan function of FIG. 15 shows ion storage times for both channels 1 and 2 as equal, it's possible to set a separate ion storage time for channel 1 and channel 2 by terminating the positive ion stream into the ion traps of a particular channel by setting the front endcap parameter to a high DC voltage, typically greater than 10 or 20 volts. This will effectively trap the ions already injected, but will also repel any further ions from entering the ion trap through the front endcap.

After the ion storage time, both channels perform a mass isolation step during the T3 1532 time period. During this time period each channel will isolate a unique ion species having a unique m/z ratio in each of the ion traps comprising that channel. As before, although the scan function displays the mass isolation times as equal for both channels, in practice each channel could have its own mass isolation time and its own mass isolation amplitude. The mass isolation time for each channel can be terminated after a given period of time by simply disabling the supplemental AC signal applied to the RIT. Also during this T3 time period, the front and rear endcaps for both channels are increased to a positive DC level sufficient to hold the trapped ions within the ion trap until the trapped ions are scanned out. This DC level to which the endcaps are raised is used to trap positive ions in the ion trap volume, and typically ranges from 10 to 50 volts DC, but may vary depending upon the physical dimensions of the ion trap.

After mass isolation, which is accomplished in the same manner as described for the scan function of FIG. 14, the fragmentation time period T4 1534 is used to fragment the isolated parent ion and generate a daughter ion spectrum. Although the fragmentation is shown as “Fragmentation 1 & 2” at 1518, the fragmentation times do not need to be the same for both channels. Channel 1 and channel 2 can each have different fragmentation times. The fragmentation time is the length of time that a supplemental AC excitation waveform is applied to the X axis electrodes of the RIT. The AC excitation waveform applied to each channel of the ion trap array will be the resonant frequency of the parent ion that was isolated during the previous time period.

After the fragmentation period T4, T5 1536 represents the ion cooling time used to allow the trapped ions to coalesce into the center of the ion trap prior to being scanned out of the trap. After the T5 time period, T6 1538 is a short period of time during which the electron multiplier voltage is activated in preparation for data acquisition. This T6 time period will vary, depending on the electronics used to drive the electron multiplier power supply, but will typically be only a few milliseconds.

The data acquisition phase for channel 1 occurs during time period T7 at 1540. During this time period ions are scanned out of the channel 1 ion traps by linearly increasing the RF Amplitude 1 1526 signal applied to the Y axis plates of the channel 1 RITs. In conjunction with the RF Amplitude 1 scan, the Resonance Ejection 1 1524 waveform is also linearly increased during this time. The resonance ejection scan will typically be increased from a low of 2 or 3 volts up to a maximum of 10 or 20 volts peak-to-peak.

During the T7 1540 time period, the ions trapped in ion trap channel 1 will be ejected in order of increasing mass/charge ratio. The ejected ions will be detected by the single electron multiplier used by the RIT array. The electron multiplier will generate an ion current that will be detected and recorded and used to generate the resultant mass spectrum of the daughter ions.

During the T7 acquisition time period, the daughter ions generated in channel 2 must be held during the acquisition time T7 of channel 1. After this T7 time period, a short time period T8 at 1542 is used to allow the RF signal of channel 1 to drop to zero, after which the ions trapped in channel 2 will be acquired. The data acquisition time T9 at 1544 is used for data acquisition of the channel 2 ions, followed by the shutdown of all parameters during time period T10 1546. This acquisition phase for channel 2 is accomplished in the same manner as the data acquisition phase for channel 1. The RF Amplitude 2 parameter 1512 is ramped, along with the ramping of the Resonance Ejection 2 parameter 1506. The data acquisition phase for channel 2 occurs immediately after the short time period T8 used to allow the RF signal of channel 1 to decay. The Data Acquisition parameter 1502 illustrates the two time periods that are used to acquire data. Since there is only a single electron multiplier ion detector, data acquisition involves acquiring data from both channel 1 and channel 2 by the single electron multiplier. The acquired data must then be separated into two different spectra and displayed as one spectrum from channel 1 and one spectrum from channel 2.

The Detector Voltage parameter 1504 is shown to be left in the active state during time periods T6, T7, T8 and T9. Since the time period T8 will be very short, typically a millisecond or less, the detector voltage should be left on during all four of these time periods. After being enabled in T6, the electron multiplier voltage is left on during acquisition of data for channel 1, and left on until the acquisition of data for channel 2 has elapsed. However, if time period T8 extends for several milliseconds or more, it would be possible to shut the Detector Voltage 1504 off during most of the T8 time period, and then turn it back on shortly before the time period T9 begins.

It can also be seen from the scan function of FIG. 15 that the front endcap of channel 2 1510, and the rear endcap of channel 2 1508, are left at a positive DC potential during the acquisition phase of ions from channel 1 during T7 1540. This is necessary since the daughter ion spectra of channel 1 and channel 2 are created simultaneously, but the two spectra cannot be simultaneously acquired. The data from each channel must be acquired in a sequential fashion. Therefore, after the daughter ion spectra are generated in each channel, the trapped ions from channel 1 are acquired first, followed almost immediately by acquisition of the trapped ions from channel 2.

As previously discussed, the lower RF voltages required for operation of a miniaturized ion trap array allow data to be acquired by scanning the RF drive frequency. This RF scanning mode may be implemented for any of the scan functions shown in FIG. 12, FIG. 13, FIG. 14 and FIG. 15. To implement this RF scanning mode, the RF amplitude is held constant during the acquisition segment, while the frequency of the RF drive signal is decreased. This will cause the ions contained in the individual ion traps to be ejected from the ion trap analyzer in increasing order of their m/z value, where they may be detected and recorded by the ion detector.

### Characterization of Individual Ion Trap Performance

The previously described method of organizing an array of ion traps into a given number of channels limits the number of channels based upon the amount of electronics used to control the ion trap array. This normally results in a situation where each channel comprises more than one ion trap. However, due to the flexibility of the control electronics, it is possible to allocate any number of ion traps to any particular channel. This allows a channel to be created that comprises only a single ion trap. In this configuration, it is possible to characterize the performance of each individual ion trap by acquiring data from a channel comprising only a single ion trap.

The characterization process involves sampling a reference compound, such as perfluorotributylamine (PFTBA), and acquiring data from a single channel that comprises only a single ion trap, and to then sequentially acquire this reference compound data from each individual ion trap in the array.

To properly acquire a representative spectrum from an individual ion trap, it will normally be necessary to increase the electron multiplier voltage substantially. The increased voltage of the electron multiplier will provide the additional gain necessary to properly detect enough ion signal to characterize the performance of an individual ion trap.

From the data acquired from each individual ion trap, it will be possible to determine which ion traps have acceptable performance, and which would be completely unacceptable for use, and which could be acceptable for use if properly controlled. This will allow the ion trap array mass spectrometer to be organized into channels, in which each channel is composed of individual ion traps having acceptable performance, with the poorly performing ion traps excluded from use.

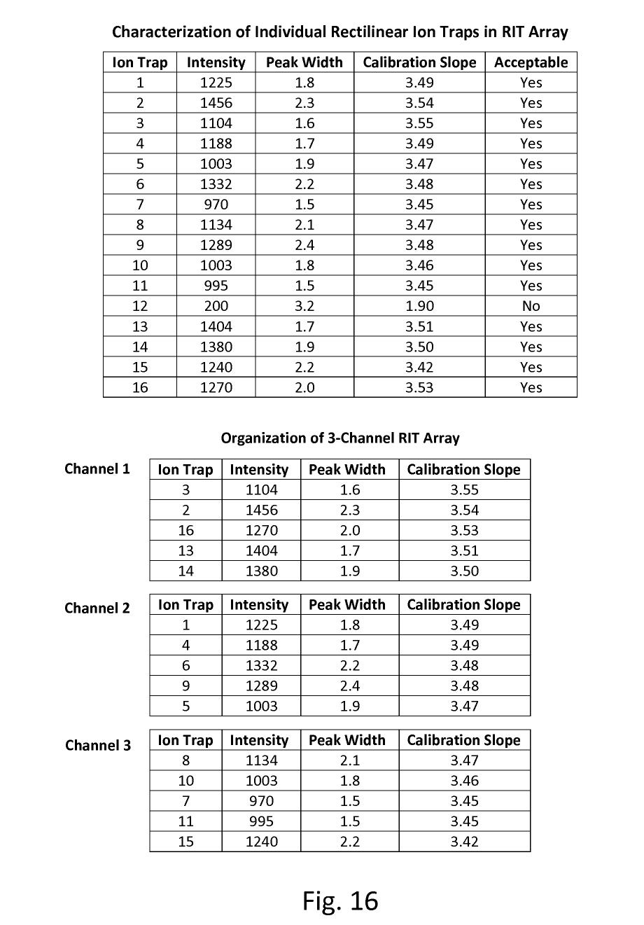

FIG. 16 shows an example of the results of performing a characterization of an RIT array of 16 individual RITs. The chart at the top of FIG. 16 shows the results of characterizing each of the 16 RITs. From this data it can be seen that 15 of the RITs were acceptable for use, but one of the RITs (number 12) was unacceptable and will not be used in any of the channels that are configured.

The lower three charts show the RITs that will comprise each of the three channels. The channel configurations have been organized on the basis of the calibration slope for each of the RITs. The five RITs with the largest calibration slopes were all assigned to channel 1. The five RITs with the next largest calibration slopes were all assigned to channel 2. The five RITs with the smallest calibration slopes were all assigned to channel 3.

From the data shown in FIG. 16, it can be seen that if all the RITs were operated in parallel, the calibration slopes of the RITs would vary from a high of 3.55 to a low of 3.42, yielding a variation of 0.13. However, by organizing the RITs into the three channels shown, the variation in channel 1 is 0.05, the variation in channel 2 is 0.02, and the variation in channel 3 is 0.05. Then, by adjusting the RF scan for each of the three channels, we can compensate for differences between the channels, but not for the differences within the channels. This still allows us to improve the variation in calibration slope from 0.13, when operating all RITs in parallel, to 0.05, when we configure the RIT array to be operated as three channels of 5 RITs each.

Although the devices illustrated in FIGS. 8 through 11, and the scan functions described in FIGS. 12 through 15, relate to ion trap mass spectrometry, it would be possible to apply these devices and methods to the technology of quantum computing. In such an application, the ability to characterize the performance of the individual ion traps would permit a quantum computer system to optimize it's performance, even when it comprises a number of defective, or poorly performing, ion traps.

In a similar manner, the devices illustrated in FIGS. 8 through 11, and the scan functions described in FIGS. 12 through 15, could be used to create a mass selection device, in which specific molecular species are isolated and then used directly for other applications, instead of being recorded as mass spectra.

### Optimization of Performance by Control of the RF Frequency

As the dimensions of the ion trap array decrease, the RF voltage required to trap and scan ions out of the ion trap also decreases. For an ion trap comprising a single ion trap analyzer, with an internal radius on the order of 1 cm, the RF drive voltage will typically be 5000 volts peak-to-peak or more. However, when an ion trap is miniaturized, and the dimensions of an individual RIT is on the order of 1 mm, the RF signal needed to drive the miniaturized ion trap will typically drop below 500 volts peak-to-peak. This allows the RF signal to be generated from solid state electronics that do not require the use of a tuned RF step-up transformer.

When the RF signal used for trapping ions in a CIT or RIT is generated from a solid state electronics device that does not require a tuned RF step-up transformer, it becomes possible to not only control the amplitude of the RF signal, but to also control the frequency of the RF signal. In this manner, the frequency of the RF signal can be adjusted for optimum performance for the ion trap array. For example, if the ion trap array has been designed to scan a mass range of 500 m/z, but the analysis being performed only requires a mass range of 300 m/z, then it is possible to increase the RF drive frequency to the point where the full scan range of the RF generator will only reach to 300 m/z. This means that at any given mass in any given scan range, the RF generator will be producing the maximum voltage possible for that mass.

The optimal increase in the RF drive frequency can be calculated from a simple analysis of the equations that describe the operation of the ion trap. The mathematics of the Mathieu parameters and the ion trap stability diagram are well understood in the industry. The conventional stability diagram used to describe ion motion within the ion trap is a plot of a_{z} versus q_{z}, in which a_{z} and q_{z} are defined as:

$${a}_{z} = - \frac{8 eU}{{mr}_{0}^{2} {ω}^{2}} \\ {q}_{z} = \frac{4 eV}{m {r}_{0}^{2} {ω}^{2}} \qquad ( 1 )$$

where e is the electron charge (1.6×10⁻¹⁹ coulombs), U is the DC voltage applied to the ion trap electrodes in volts, m is the mass of the contained ions, r₀ is the internal radius of the ion trap in cm, ω is the RF drive frequency in radians/second, and V is the amplitude of the RF signal in Volts₀₋ₚ. However, typical operation of the ion trap during scanning does not apply a DC voltage to the ion trap electrodes, which sets the a_{z} parameter to zero.

Therefore, if we lower the operating mass range of the ion trap, we can increase the operating frequency of the ion trap, and still maintain the same q value by identifying the following:

$${q}_{z 1} = \frac{4 e {V}_{max}}{{m}_{1} {r}_{0}^{2} {ω}_{1}^{2}} \\ {q}_{z 2} = \frac{4 e {V}_{max}}{{m}_{2} {r}_{0}^{2} {ω}_{2}^{2}} \qquad ( 2 )$$

where Vₘₐₓ is the maximum RF voltage reached when the ion trap is scanned to its highest mass/charge value, m₁ is the original mass range of the ion trap, m₂ is the lower mass range that we want to select, ω₁ is the original RF radial frequency used to scan the original mass range, and ω_{z} is the new higher radial frequency that can be used with the lowered mass range of the ion trap. Therefore, since we want to keep q_{z2} equal to q_{z1} after the mass shift from m₁ to m₂, we find:

$$\begin{matrix}\frac{4 e {V}_{max}}{{m}_{1} {r}_{0}^{2} {ω}_{1}^{2}} = \frac{4 e {V}_{max}}{{m}_{2} {r}_{0}^{2} {ω}_{2}^{2}} \\ and & ( 3 ) \\ \frac{{m}_{2}}{{m}_{1}} = {( \frac{{ω}_{1}}{{ω}_{2}} )}^{2} & ( 4 )\end{matrix}$$

which yields the formula that will give us the new frequency for the RF drive signal that can be used when we change the acquisition mass range of the ion trap:

$${ω}_{new} = {ω}_{0} \sqrt{\frac{{m}_{0}}{{m}_{new}}} \qquad ( 5 )$$

where m₀ is the initial acquisition mass range of the ion trap, ω₀ is the initial RF drive frequency for the initial acquisition mass range, m_{new} is the new mass range, and ω_{new} is the new RF drive frequency for the new mass range.

The higher frequency produced, along with the subsequent higher RF voltage, will allow for an increase in the storage capacity of the ion trap, which directly increases the sensitivity of the mass spectrometer. The higher frequency will also allow for an improvement in the fragmentation efficiency during an MS/MS acquisition, as the ions will have more energy when they collide with the neutral molecules present in the ion trap analyzer.

While increasing the RF drive frequency has benefit in improving ion storage capacity, and MS/MS fragmentation efficiency, it is also possible to use the equation of (5) to increase the mass range of the ion trap, by simply using an m_{new} value that is greater than m₀, and then adjusting the RF drive frequency to the calculated ω_{new} value. This will normally result in some degraded performance when we lower the RF drive frequency, but for certain applications where an extended mass range would be beneficial, the ability to adjust the RF drive frequency provides a significant advantage.

1. An apparatus comprising an array of ion trapping devices in which;
a. said ion trapping devices utilize RF electric fields to trap ions within a defined volume;
b. an electrical switching system is used to connect said ion trapping devices to separate sets of control electronics;
c. said electrical switching system is capable of connecting a variable number of said ion trapping devices to a variable number of said control electronics, permitting said ion trapping devices to be organized into channels, with each channel comprising a plurality of said ion trapping devices electrically connected in parallel; and
d. each of said channels is controlled through said control electronics by changing one or more parameters, which include the RF drive amplitude, the RF drive frequency, the DC offset of the RF drive signal, and the amplitude and frequency of the AC signal applied to one or more electrodes of said ion trapping devices.

2. The apparatus of claim 1, in which said array of ion trapping devices is used to function as a mass selection device.

3. The apparatus of claim 1, in which said array of ion trapping devices is used in combination with at least one ion detector to function as a mass spectrometer.

4. The apparatus of claim 3, in which said ion trapping devices are cylindrical ion traps.

5. The apparatus of claim 3, in which said ion trapping devices are rectilinear ion traps.

6. The apparatus of claim 3, in which said ion trapping devices are linear ion traps.

7. The apparatus of claim 3, in which said ion trapping devices comprise a mixture of cylindrical ion traps, rectilinear ion traps, and linear ion traps.

8. (canceled)

9. (canceled)

10. (canceled)

11. (canceled)

12. (canceled)

13. The apparatus of claim 5, in which said individual rectilinear ion traps are controlled by a supplemental AC signal applied to only one X axis plate of each of said rectilinear ion traps, in which the other X axis plate of each of said rectilinear ion traps is connected to a ground potential.

14. The apparatus of claim 6, in which said individual linear ion traps are controlled by a supplemental AC signal applied to only one X axis hyperbolic rod of each of said linear ion traps, in which the other X axis hyperbolic rod of each of said linear ion traps is connected to a ground potential.

15. The apparatus of claim 3, in which the frequency of the RF drive signal of said individual ion trapping devices can be changed, and said change is used to optimize the performance of said individual ion trapping devices by calculating and setting the frequency of said RF drive signal to a value that will require said RF drive signal to scan to its full voltage range to achieve the desired mass range of said individual ion trapping devices.

16. (canceled)

17. (canceled)

18. (canceled)

19. (canceled)

20. A method of controlling an array of individual ion trapping devices, in which the frequency of the RF signal driving said individual ion trapping devices is changed to optimize the performance of said individual ion trapping devices by calculating and setting the frequency of said RF signal to a value that will require said RF signal to scan to its full voltage range to achieve the desired mass range of said individual ion trapping devices.
